(19) United States
(12) Patent Application Publication
(10) Pub. No.: US 2016/0350818 A1
(43) Pub. Date: Dec. 1, 2016

(54) Integrated Hospitality and Restaurant Management System

(71) Applicant: Tatchi Solutions, Inc., Libertyville, IL (US)

(72) Inventors: Faisal Saeed, Libertyville, IL (US); Zia Hasnain, San Jose, CA (US); Asif Muhammed Rao, San Jose, CA (US)

(73) Assignee: Tatchi Solutions, Inc., Libertyville, IL (US)

(21) Appl. No.: 14/726,926

(22) Filed: Jun. 1, 2015

(51) Int. Cl. G06Q 30/02; G06Q 50/12; G06Q 30/06; H04L 29/08

(52) U.S. Cl. CPC G06Q 30/0282; H04L 67/10; G06Q 50/12; G06Q 30/0643

(57) ABSTRACT

A smart table configured to optimize hospitality management for hospitality venues. The smart table integrates communication systems, sensors, payment solutions, smart apps, mobile and embedded smart devices with cloud and big data back end solutions to create a complete ecosystem. The primary objective of this invention is to provide a fully integrated data and multimedia experience to customers, employees, and owners of hospitality venues. Hardware components include but are not limited to host servers, smart tables providing customers interactive multimedia, social media, menu selections, and payment options, and employee tablets or computers to interact with the system and customers as well. Software components include but are not limited to server management software and mobile application software and web software for users to interact with the server management software.

### BACKGROUND OF THE INVENTION

The present invention relates to hospitality service provider and restaurant management systems and accompanying hardware. Existing inventions include digital menus displayed on portable tablets screens in restaurants, games and interactive trivia displayed on fixed and portable tablet screens at restaurant tables, the ability to book reservations over the internet, and the ability to pay for and order food over the internet. These ad hoc pieces leave customers, hospitality service providers and restaurants unfulfilled because the components of these systems are not integrated in a way to give meaningful experiences to customers, hospitality service providers and restaurants alike.

As opposed to ad hoc management and entertainment pieces, fully integrated systems can be used to manage restaurant data and customer interactions and allow for complete control of all the data exchange between the customer and the hospitality service providers or restaurant. These systems are easy to maintain and support with single interfaces that aim to reduce human data entry errors. Full integration means eliminating redundancy and allowing seamless inter-component communication. Monitoring and supporting of non-disparate systems leads to a better collaboration and interaction among different system components and increased over all productivity and save cost.

Current fully integrated systems have limited hardware and software capability. It is advantageous for a business to have a single scalable system comprised of hardware and software components and modules with unlimited upgrade flexibility.

### SUMMARY OF THE INVENTION

The Integrated Restaurant Management System (IRMS) is a complete end to end hospitality service provider (which may include but is not limited to restaurants, cafes, hotels, stadiums, food courts, and parks, hereinafter referred to as “restaurant”) management solution comprising swappable and scalable software and hardware components. When the components are integrated under one system, the processes of restaurant food ordering, payment, inter and intra-restaurant social networking, interactive multiplayer inter and intra-restaurant gaming, targeting advertisements, coupon redemption, creating menu ratings and reviews, making retail purchases, purchasing movie ticket ahead of a show, become seamlessly automated and can be performed from the mobile devices and “smart tables.”

Components of IRMS ecosystem include a computer input device and display that acts as an interface to the rest of the IRMS system by communicating user requests to a computer sever and in turn receiving user responses from the computer server. The computer server processes user requests and applies predefined logic to connect to the other physical or logical components within the ecosystem or to third party ecosystems.

Restaurant customers directly interact with the IRMS via a “smart table” comprised of multiple computing devices and peripherals that is connected to the IRMS server network using. The table comprises an embedded or mounted tablet device and a number of embedded peripheral accessories that utilize multi-purpose sensors, multimodal biometric authentication technologies, mobile payment technologies to create a seamless dining and entertainment experience.

### BRIEF DESCRIPTION OF THE DRAWINGS

The following drawings are given for illustrative purposes only and are not meant to limit the present device:

FIG. 1 is a diagram representing the operation of the IRMS system in a chain of restaurants connected to the IRMS back end cloud server;

FIG. 2 is a diagram representing the operation of the IRMS RSM module;

FIG. 3 is a diagram representing the operation of the IRMS FCCM module;

FIG. 4 is a diagram representing the operation of the IRMS Chef Console Module;

FIG. 5 is a diagram representing the operation of the IRMS Manager Console Module;

FIG. 6 is a diagram representing the operation of the IRMS Administrator Console Module;

FIG. 7 is an isometric view of an IRMS table assembly with a single tablet assembly embedded into the IRMS table top;

FIG. 8 is a front view of the payment module assembly;

FIG. 9 is a top view of the sensor pad assembly;

FIG. 10A and FIG. 10B illustrate isometric views of an IRMS tabletop with single tablet assembly attached to the tabletop via a hinge assembly;

FIG. 11 is an isometric view of an IRMS tabletop with single tablet assembly attached to the tabletop via a hinge and rail assembly; and

FIG. 12 is a diagram representing the operation of the IRMS Corporate Cloud Management System (CCMS).

FIG. 13 is a diagram depicts a complete IRMS ecosystem.

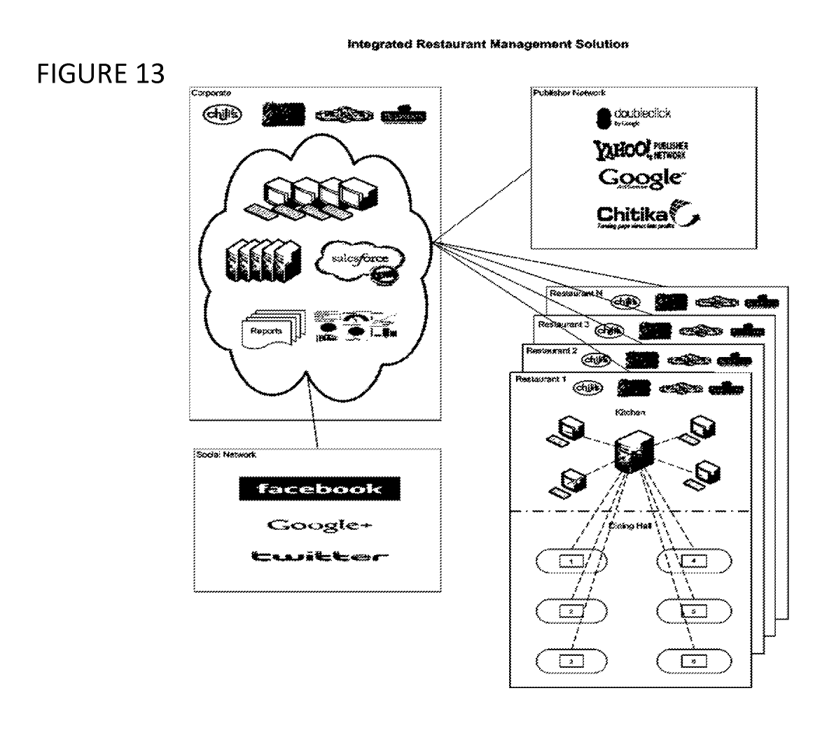

FIG. 14 is a diagram depicts the components in content management system.

### DETAILED DESCRIPTION OF THE INVENTION

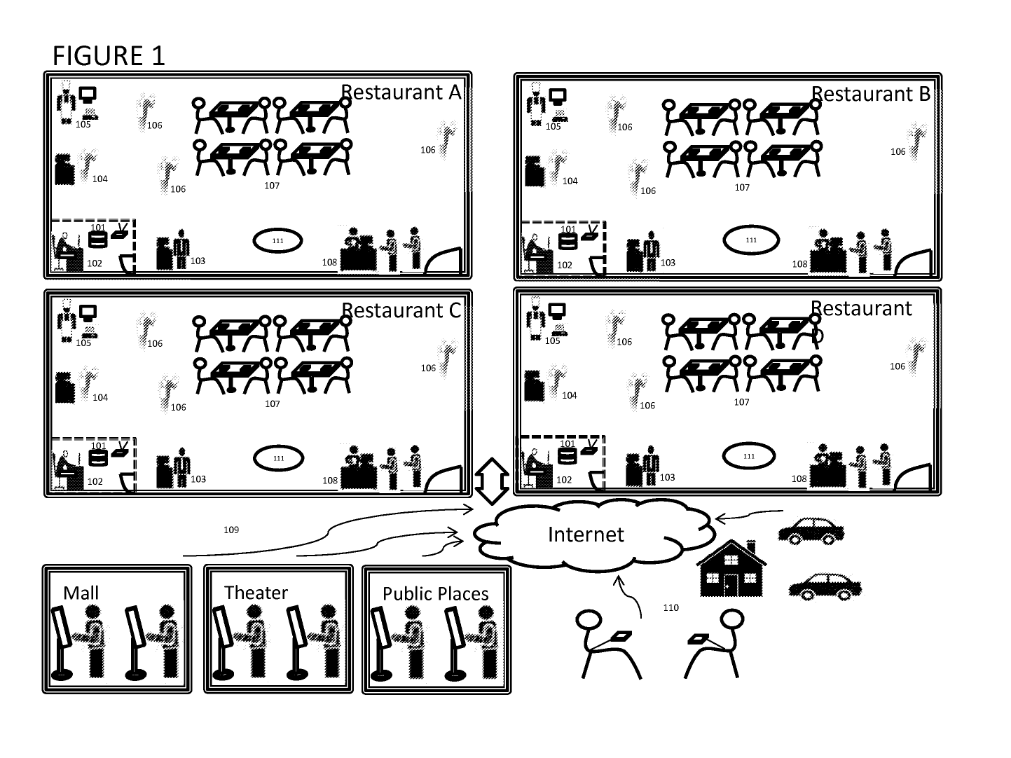

With specific reference to the drawings, FIG. 1 in its entirety represents an Integrated Restaurants Management Solution (IRMS) system. The IRMS system substantially comprises a computer Server Module (SM) used to host the IRMS management software 101, an Administrator Console Software Module (ACM) to manage, maintain, and operate the IRMS management software 102, a Manager's Console Software Module (MCM) configured for a restaurant's manager to control and operate the IRMS system within the restaurant 103, a waiter's software console configured for a waiter to be able to communicate with both customers and other staff members 104, a Chef Console Software Module (CCM) configured for a chef to be able to communicate with the wait staff 105, a waiter to serve the food and beverages ordered 106, an electronic input device and display such as a tablet computer with a Request Submission Software Module (RSM) 708 configured to interface with the IRMS server and take customer requests, orders off a digital menu, and payments 107, a Front Counter Console Software Module (FCCM) configured with a restaurant layout database to be used by a restaurant host to find seating, take reservations, view diner's profile and preferences 108, public smart kiosks configured to place advance orders, make advance reservations, and interact with the IRMS from outside a restaurant 109, computer, smartphone, and automobile software configured to place advance orders, make advance reservations, and interact with the IRMS generally 110, and at least one restaurant integrated with the computer server and electronic input devices 111.

The IRMS system is customizable for each restaurant or restaurant chain's needs. In the case where a single restaurant may not have a host or hostess and therefore, have no need for the FCCM 108 because customers can seat themselves, the restaurant manager can disable the FCCM. In the case where a restaurant does not want customers to be able to order in advance from additional mobile applications 109 and smart kiosks within the IRMS 110 , the restaurant manager could disable the “order in advance functions”.

The IRMS system can be divided into three subsystems, individual store subsystem (ISS), Backend Cloud Corporate Subsystem, Content Management Subsystem.

### Individual Store Subsystem—ISS

The ISS is a software and hardware subsystem that can be configured to run on a standalone server or integrated with a restaurant's existing back-end system by populating a shared database. The ISS subsystem comprises various software venue management system modules. These modules include but are not limited to a Request Submission Software Module (RSM), a Front Counter Console Software Module (FCCM), an Administrator Console Software Module (ACM), a Manager Console Software Module (MCM), a Chef Console Software Module (CCM), a Server Module (SM), and a Payment Module (PM).

### RSM

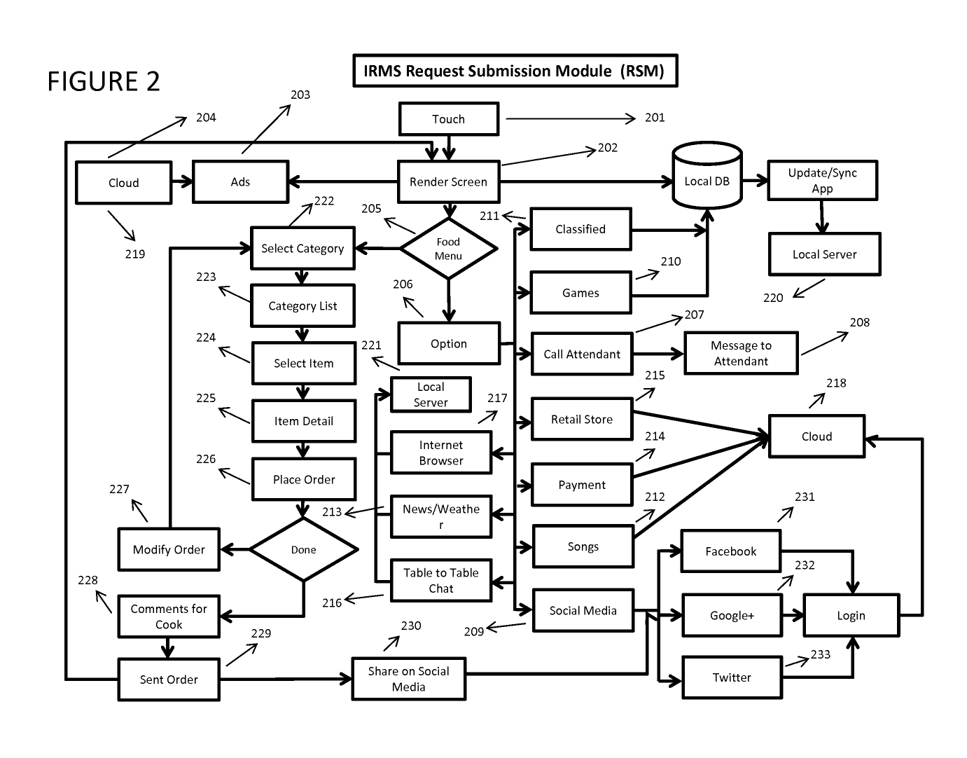

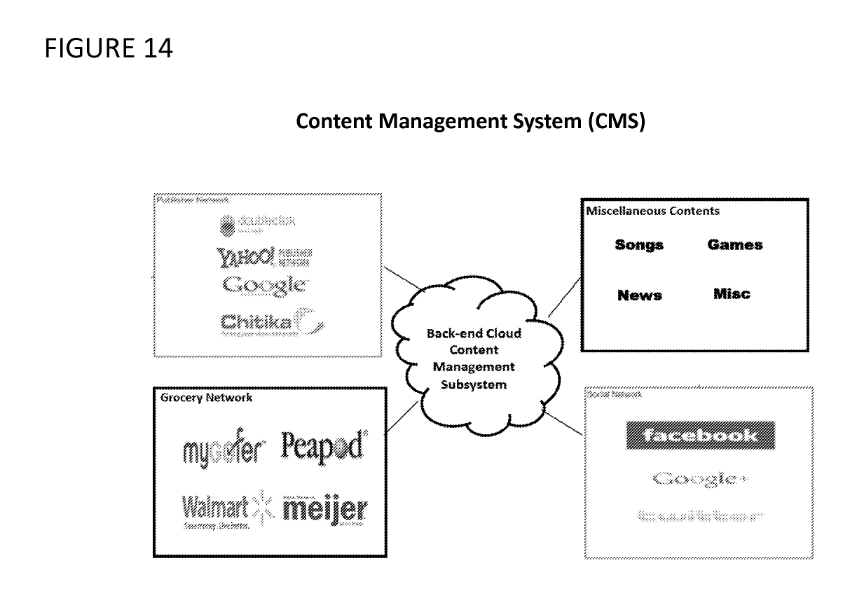

The Request Submission Software Module 708 is the interface software module installed on both a computer server and a computer input device and display in communication with the server. The RSM is configured to allow customers and additional system users to interact with the IRMS through the computer input device and display. This interaction includes the ability to place an order with the restaurant, play games, pay the bill, call the waiters attention, send messages to other customers, connect with social media, and make in-restaurant announcements. FIG. 2 is a diagram representing the execution of the RSM on a computer input device and display and a computer server. The display on the computer input device is activated via a touch 201 from the customer. A new screen is rendered 202 and the customer is then presented with a screen which can display targeted advertisement 203 retrieved from advertisement databases stored on the computer server 204 and also display an options to access the digital food and beverage menu 205 and an options menu that are both stored on the computer server in a database 206. The options menu presents customer selectable (touchable) options such as call the waiter to attention 207, 208 by sending a message through the computer input device and display to the computer server and the computer server paging the waiter's computer input device and display. Other selectable options include access to various social and digital media content 209 such as the customer's personal ordering profile and preferences, games 210, classified ads 211, music 212, news 213, payment options 214, retail purchase options 215, table to table chat 216, Internet Browser 217. 218 and 219 represent a set of servers connected to third party content providers such as music content management systems, including but not limited to iTunes or Spotify, payment processing servers, grocery or retail stores, and targeted advertisement servers. The content server diagram is also depicted in FIG. 14. Local servers 220 and 221 represent an in-house set of servers that are local to an individual store.

Through the use of the computer input device and display customers may utilize the RSM to register personal profiles stored in a user profile database within the IRMS. The database can hold information such as customer email addresses and personal information, restaurant loyalty rewards, dietary preferences, restrictions, and allergens such that the digital food and beverage menu will filter out any items outside of the customers restrictions, or even seating preference so that a restaurant host using the IRMS will be prompted by the IRMS with a table that meets the customer's preferences. The data in the profile database can be shared with the advertisement database and advertisement server to display targeted ads based on the profile data on the computer input device and display.

The digital food and beverage menu are stored in a database on the computer server and can be accessed and viewed through the RSM on a computer input device and display in communication with the ISS. The digital menu 205 allows for multi-page navigation by virtually sliding pages through a swiping action sideways or up and down. The customer is able to see categories of foods and beverages available 222, select from that category list 223, select an item 224, view the item detail 225, place the order 226, modify the order 227, provide special comments to the chef 228, and send the order in through the computer input device and display to a database on the computer server accessible to the restaurant chef and wait staff on an additional computer input device and display 229. Each digital menu entry can provide a description of an item, image(s) of the item, and may present options to the user, such as the option to display other customer reviews about the item. In addition, the digital menu entry can include facts about the item, dietary facts about the item, the option to add comments and share the consumer's thoughts 230 about the item or restaurant via social networking applications such as Facebook 231, Google +232, and Twitter 233. The customer may add their own images of items using their own mobile devices and upload the images to the digital menu database to be displayed along with the digital menu items after approval of the restaurant management.

Customers may also use the RSM interface to rate digital menu items. Through the computer input device and display, the customer may select a digital rating that is then stored in a database of digital rating on the computer server and the rating is linked to the digital menu. Through the use of additional software modules, the ratings data can be collected and sorted to reflect a customer's likes and dislikes associated with each menu item at any particular time or time range.

The social and digital media content may include but is not limited to a gaming menu that will allow customers to play preloaded and downloadable games on the input device, a chat and announcement menu that will allow the customer to securely chat (text, voice, or video conference) via the input device with other customers at different tables within the same restaurant or chain of restaurants, a classified ads menu that will allow customers to post classified ads to the restaurant's virtual bulletin board in the nature of local real estate, local jobs, local services, selling items and local events, and a music menu that will allow the customer to both purchase music and queue up music in an existing restaurant audio system. The social and digital media services may also include a book or game exchange service, where people can exchange or sell their games, textbooks or other books. An opportunity for storeowners to make extra revenue by charging nominal fee for these services.

### Front Counter Console Module—FCCM

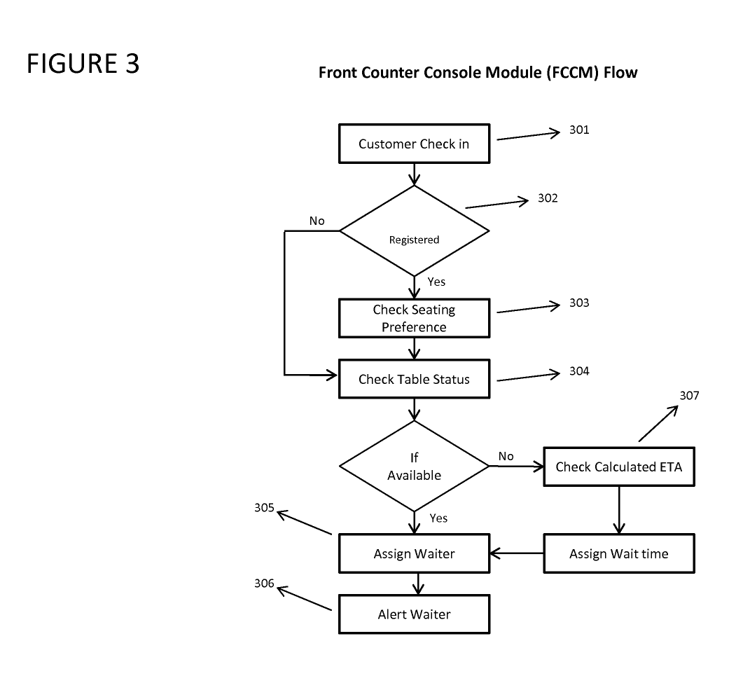

The Front Counter Console Module (FCCM) is a software interface of the IRMS system that is designed to be used by either a cashier or host of a restaurant. With the FCCM an employee can log onto a secure portal via a computer input device and display with IRMS access to assign a table to new customers and wait staff. The FCCM is diagramed in FIG. 3. Once an employee is logged into the system, the employee can check the customer in 301, check to see if that customer has a registered profile 302 and assign seating based on table preference of their registered profile 303, check status of open tables 304. If the table is open, the FCCM will assign a waiter 305, and have the waiter alerted through the server of a new customer at their table 306, if no table is available, the FCCM will calculate and assign wait time 307 and alert the customer and waiter when a the table becomes available.

The FCCM is linked to the RSM customer profile database and can check if the customer has a pre-defined seating preference. If the RSM customer profile indicates a seating preference, the FCCM will use the seating preference data to search the restaurant table layout database to recommend a table that is closest to the customer seating preference.

### Chef's Console Module—CCM

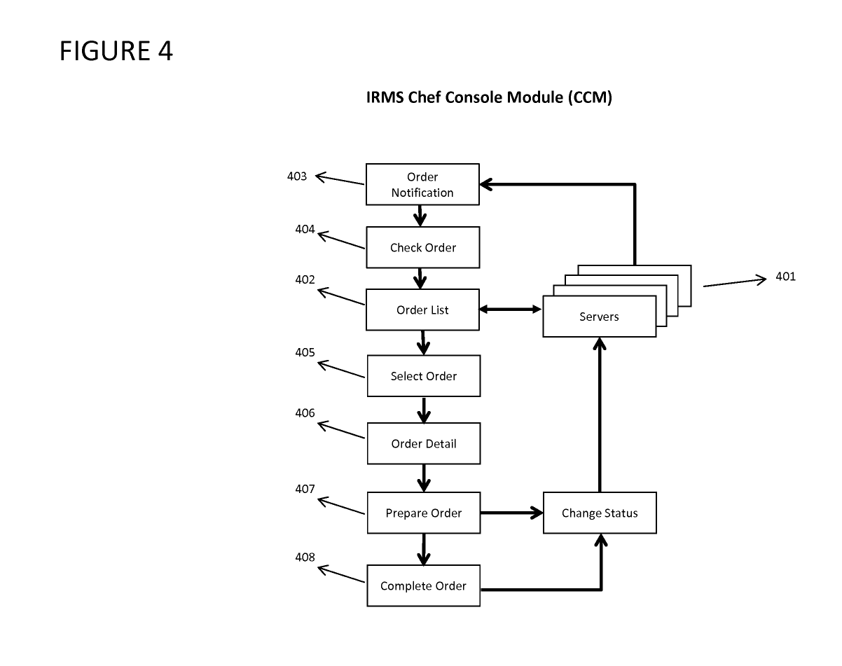

The Chef's Console Software Module (CCM) is a software interface of the IRMS system configured to manage orders and delivery of food for a restaurant chef and wait staff. The CMM is diagramed in more detail in FIG. 4. Once a customer places an order through the computer input device via the RSM, the computer server 401 stores the order in the “Order List” database 402 that the CCM accesses. The CCM notifies the chef via the chef's computer input device and display when a new order 403 has been entered into the Order List and prompts the chef to check the order 404. The orders can be labeled and sorted in the database by table number and sorted by time of entry as well. Once the chef selects the order via the computer input device and display 405, she can view the order details 406 and begin preparing the order 407. When the order is complete, the chef marks the order complete on the computer input device and display via the CCM 408, and the wait staff is notified through the computer server on their computer input devices and displays to bring the order out to the customer. In restaurants without a wait staff, such as in a fast food setting, the CCM can notify the customer directly through the RSM that their order is available and to pick up their food at the front counter themselves.

### Manager's Console Module—MCM

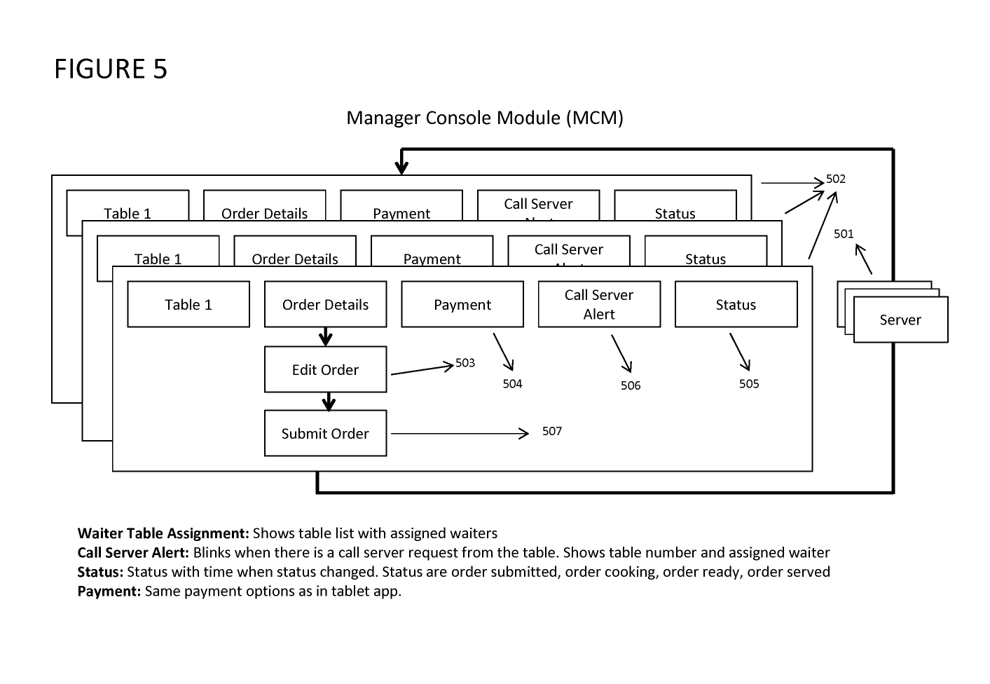

The Manager's Console Software Module (MCM) is a software interface of the IRMS system that is configured to oversee the general activity and interactions between the customer, wait staff, and chef. The MCM is diagramed in more detail in FIG. 5. The MCM communicates with the IRMS computer server 501 to select the database containing table information 502, view and edit order details of that table from the order database 503, view payment information from the payment database and collect payments via communication with the RSM and the computer input device 504 and to compile reports from a particular table or group of tables concerning what was ordered and at what time 505. The MCM also communicates with the IRMS computer server to allow a manger to call a member of the wait staff over to a particular table by communicating through the IRMS computer server to the wait staff's computer input device and display 506. The MCM may override any data placed in the system by any other module and be used to submit 507 and edit orders 503, and check on the CCM status 505, and see if a table is empty or occupied. When a customer uses the RSM to call the wait staff, both the MCM and the CCM are alerted with a sound, blinking light, or vibration giving the opportunity for a manager to send a member of the wait staff over to the customer's table. The MCM also allows the manager to send text, audio, or video messages or announcements to tables individually or as a group that appear on those tables via the RSM.

### Administrator Console Module—ACM

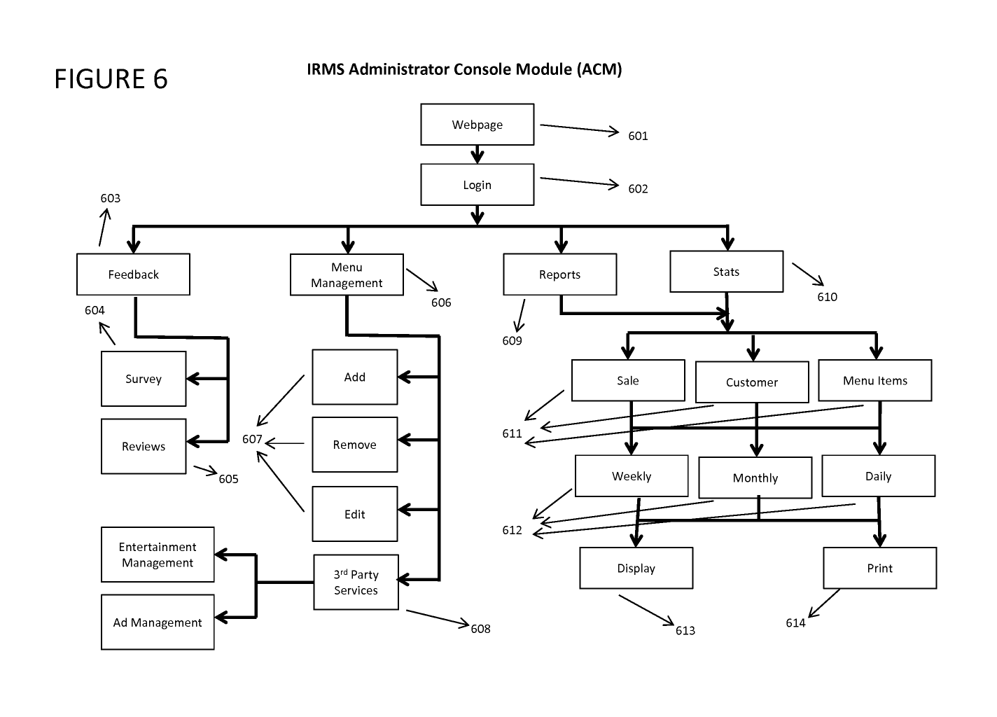

The Administrator Console Software Module (ACM) is a software interface of the IRMS system configured to manage the customer's RSM interface. The ACM is diagramed in more detail in FIG. 6. Managers or administrators may log into the ACM using any device that has internet access via the secure administrator's portal website 601. Once logged in 602, the user will have the ability to select options such as Feedback 603 to create surveys 604 and view the customer review database on the IRMS server 605, Menu Management 606 to edit, add or remove menu options 607 or advertisements and entertainment management via third party 608 that appear for the customer through the RSM on the computer input device and display. The

ACM can generate reports 609 and statistics 610 based on data shared from the customer profile database, sales database, and digital menu databases 611. The reports can compile data for individual hours, days, weeks, months, years 612, 613, and 614.

### Server Module—SM

The Server Module (SM) 101 is a software element of the IRMS system that is made up of all the individual ISS modules and contains the mutually shared databases used by each module. The SM is responsible for coordinating and controlling all individual software modules and in some variations communicating directly with the Corporate Cloud Management System (CCMS) and Content Management Subsystem (CMS).

### Input Devices

Input devices for the IRMS include but are not limited to smartphones with the IRMS app, computers, portable tablets with the IRMS app, public kiosks with the IRMS app, and smart tables with the IRMS app. Smartphones, portable tablets, and public kiosks can operate as input devices through the IRMS app that will allow the customer to make reservations and order in advance, the app will connect to the restaurant's server and be able to access the customer's personal profile and the restaurant's menu for ordering in advance. The app will also allow users to pay in advance and pickup food later via entering credit card information into the app or paying with services such as PayPal.

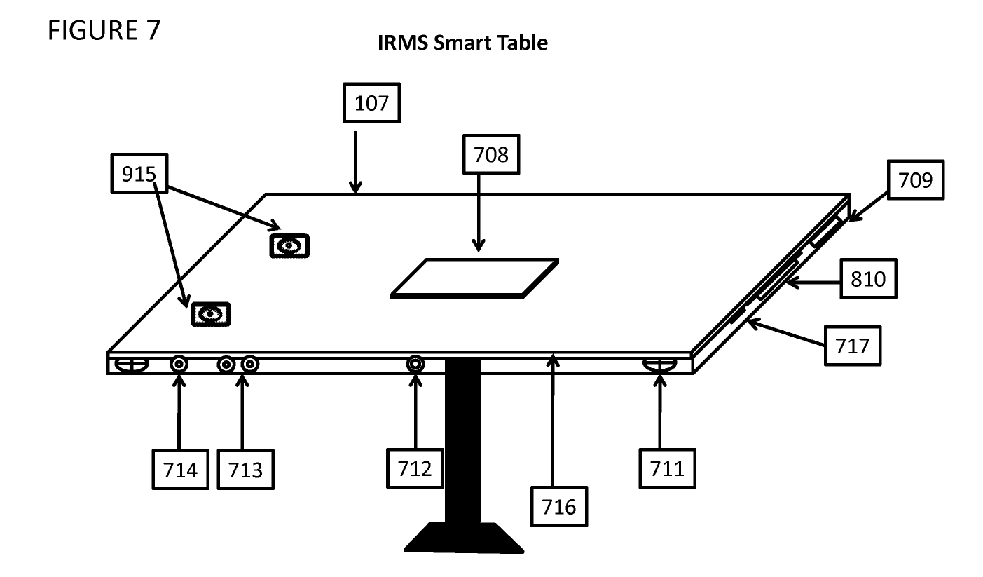

FIG. 7 is an isometric view representing one embodiment of a smart table input device. A smart table 107 may comprise of at least one (1) embedded computer tablet device with means to communicate with an external server via the internet or intranet 708, an embedded or removable power supply to power the smart table 709, a payment module to allow the customer to pay at the table 810, embedded printer module to print receipt 717, embedded audio speakers to allow the customer to have audio feedback from the multiple applications 711, an embedded headset jack to allow the customer to have audio feedback from the multiple applications 712, volume buttons to enable the customer to control the volume of the audio feedback from the multiple applications 713, a power/reset key to shut the power the table off or reset the table 714, multiple sensor pads to allow the customer additional interactive functionality 915, a wood, glass, plastic, or comparable material table top 716. The smart table 107 may be a complete table or may be a pre-manufactured table top that can be clamped or affixed by similar means to already existing tables.

The embedded tablet computer device 708 in FIG. 7 may be an existing off the shelf touch screen enabled computer tablet or a customized touch screen enabled tablet assembly of varying display sizes. All of the peripheral devices comprising the smart table 107 will be connected to and controlled by the tablet computer device and RSM software interface that is installed on the tablet computer device. The computer tablet device 708 and peripherals are connected to an external power supply 709 to provide additional power to the smart table 107. The external power supply 709 may be a removable and rechargeable battery or a non-removable power supply that may be plugged directly into a power outlet.

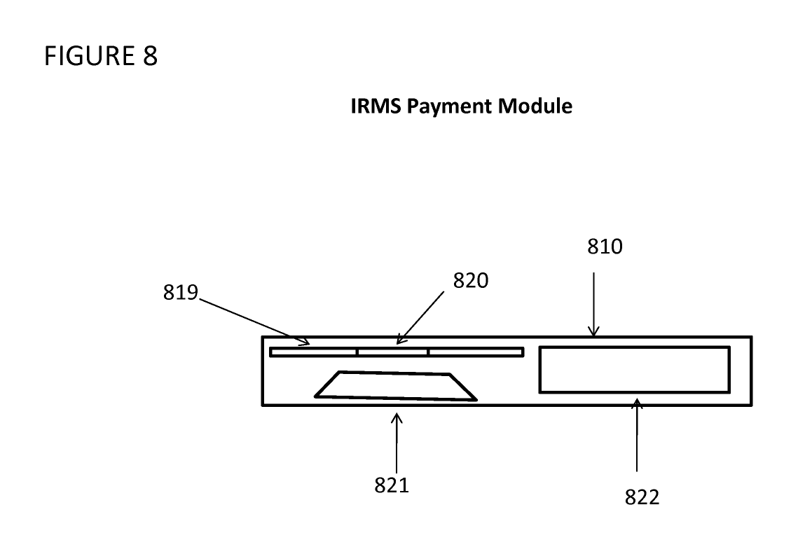

The payment module 810 of the smart table 107 is detailed in FIG. 8. The purpose of the payment module is to allow customers to pay their restaurant bill or for their IRMS content directly from the table. The payment module 810 is a hardware assembly primarily comprising a credit card reader 819, or similar credit card style reader such as a Square module reader to process Square based payments or PayPal module reader to process PayPal payments 820, an Near Field Communication (NFC) antenna to process NFC mobile payment transactions such as Apple Pay or Google Wallet 821, and Bluetooth hardware equipped with BLE to be able to process future Bluetooth payment services 822. The payment module 810 may be embedded into the side of the smart table or mounted on the underside of the smart table. The payment module 810 may be powered directly from lines running from the external power supply 709 and may be connected to the tablet 708 via wireless Bluetooth, Wi-Fi, wired USB, or similar data connections such as but not limited to 3G, 4G, LTE. The payment module 810 functions and operations are controlled by subroutines of the RSM interface software installed on the embedded tablet 708.

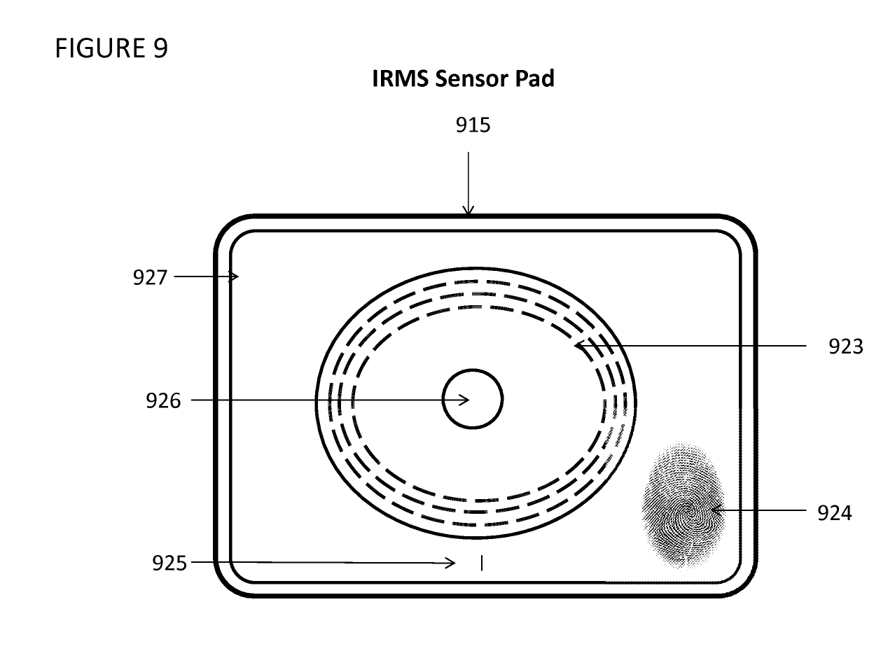

Each smart table 107 may have at least one (1) modular senor pad 915 embedded into the table and connected to the tablet 708 to provide additional information to the IRMS system processed by the RSM. The modular sensor pad 915 may be powered directly by the external power supply and may be communication with the tablet computer device via wired or a wireless connection means. FIG. 9 is a detailed top view of the modular sensor pad 915. The modular sensor pad 915 includes an NFC antenna in communication with a processor 923 to allow for customers to wirelessly charge their NFC compatible mobile devices or send data from their NFC compatible mobile devices such as images to the IRMS. Additionally included and in communication with the modular sensor pad processor is a biometric sensor that can read fingerprints and/or retinas 924 to allow the customer to quickly log into their RMS profiles. The modular sensor pad also includes a capacitive touch pad 925 to allow the customers to control the tablet 708 without having to reach across the table. Another feature of the modular sensor pad is a pressure/weight sensor 926 for beverage management, and a lighted border 927 to outline the sensor pad for the customer. When a customer places a beverage on the pressure/weight sensor 926 the beverage management module of the RSM is automatically activated. The beverage management module takes the pressure data from the sensor and monitors the sensor for changes in pressure. If there is a prolonged period of low pressure on the sensor, the RSM will ask the customer if their drink is low or if they have removed their glass from the sensor. If the customer's drink is low, the RSM will notify the customer's waiter through the computer server that the customer's drink is low and prompt the waiter to bring a refill.

Variations of the smart table 107 may include any number of additional peripherals embedded into or mounted onto the smart table and wired or wirelessly to the computer tablet device. These peripherals may include devices to provide users a virtual reality dining experience by displaying using existing holographic displays to make menu items appear three dimensional in nature in conjunction with software that would allow users to zoom, pan, and rotate virtual menu items 717. In addition to providing a three dimensional visual experience, Scent Synthesizers and cartridges (as described in U.S. Pat. No. 6,556,272 B1 or similar devices) may also be embedded or mounted onto the table to provide synthetic food aromas to the user that match menu items 718.

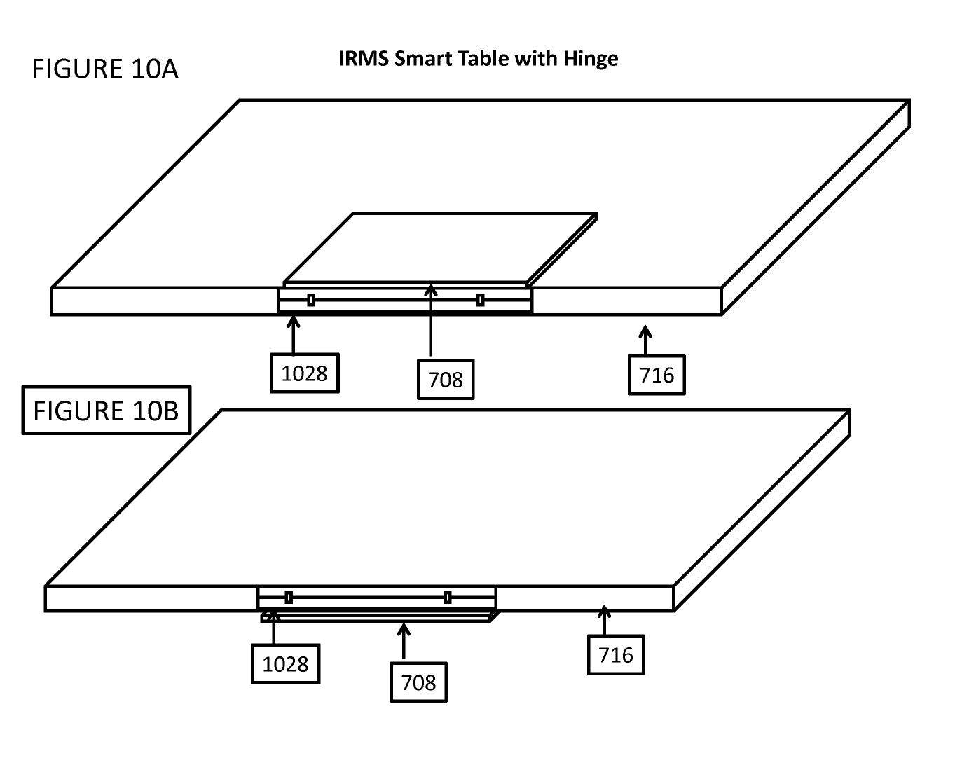

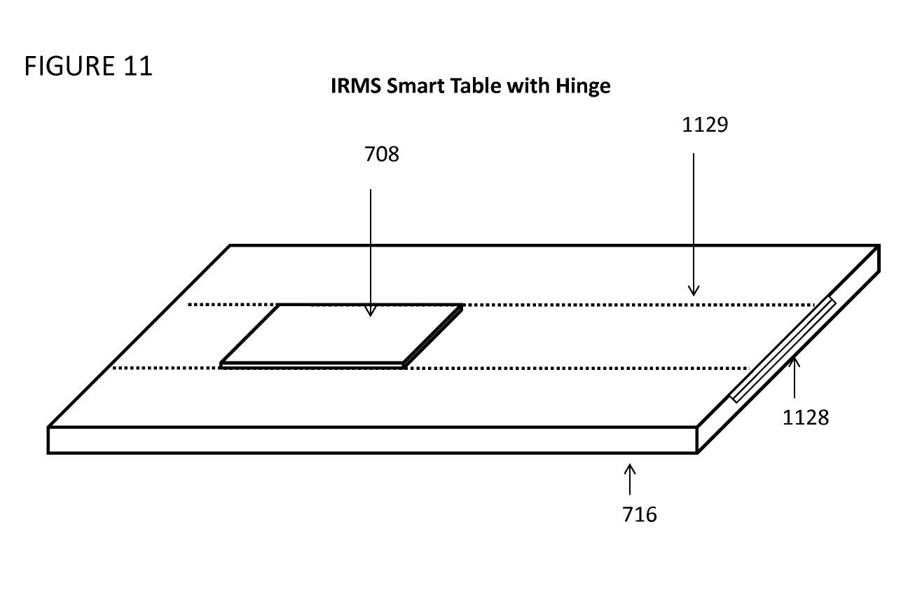

Variations of the smart table may have the computer tablet device 708 attached externally to the table to as opposed to embedded. FIGS. 10A and 10B detail a version of the smart table in which the tablet device is not embedded into the table top 716. FIG. 10A shows a computer tablet device 708, attached to a hinge mechanism 1028 that allows the computer tablet device 708 to freely rotate one hundred eighty degrees (180°) such that the computer tablet device 708, may sit on the top of the table top 716, or as displayed in FIG. 10B, rotate to hide under the table top 716 when not in use. Another variation of a smart table 107 with an externally mounted tablet is displayed in FIG. 11.

The variation displayed in FIG. 11 shows the computer tablet device mounted to the table top 716 and locked between a set of rails 1129 allowing the tablet to freely translate on the table top 716 in the direction of the rails 1129. In this variation, the ends of the rails can have stopping devices or closed off ends to prevent the computer tablet device 708 from falling off the table top 716. In another variation, the rails 1129 may have a stopping device at one end, and hinge device 1128 to allow the tablet to be rotated and hid under the table top 716, when not in use. In this variation, when the computer tablet device 708 is slid into the hinge device end 1128, the computer tablet device 708 locks into the hinge device 1128 and is longer held in place by the rails 1129.

### Content Management Subsystem—CMS

The Content Management Subsystem (CMS) FIG. 14 is a software element of the IRMS system configured to communicate directly with the RSM to provide and manage all of the content and media services that a customer may use through the RSM interface. This subsystem communicates with the SM and is used to send and receive direct requests from the RSM to content service providers such as Facebook, Google+, Twitter, Spotify, or Flickr. This subsystem may act as an abstraction layer between the content provider and the RSM on the input device. The CMS is configured to add and remove content providers as seen fit by restaurant management. Main content providers that are part of the system include bur are not limited to advertising publisher networks, grocery retailers, music providers, social networks, and games provider.

### Corporate Cloud Management System (CCMS)

The Corporate Cloud Management System (CCMS) is a subsystem of the IRMS configured to control multiple restaurants and SMs and provide the back-end processing and coordination between multiple restaurants and outside content providers. The CCMS subsystem is designed for corporations to provide consistent setups and experiences across all restaurants from a single back end computer server. The CCMS is configured for a corporate administrator to manage the content on this subsystem and configure this subsystem to push content to individual store subsystems.

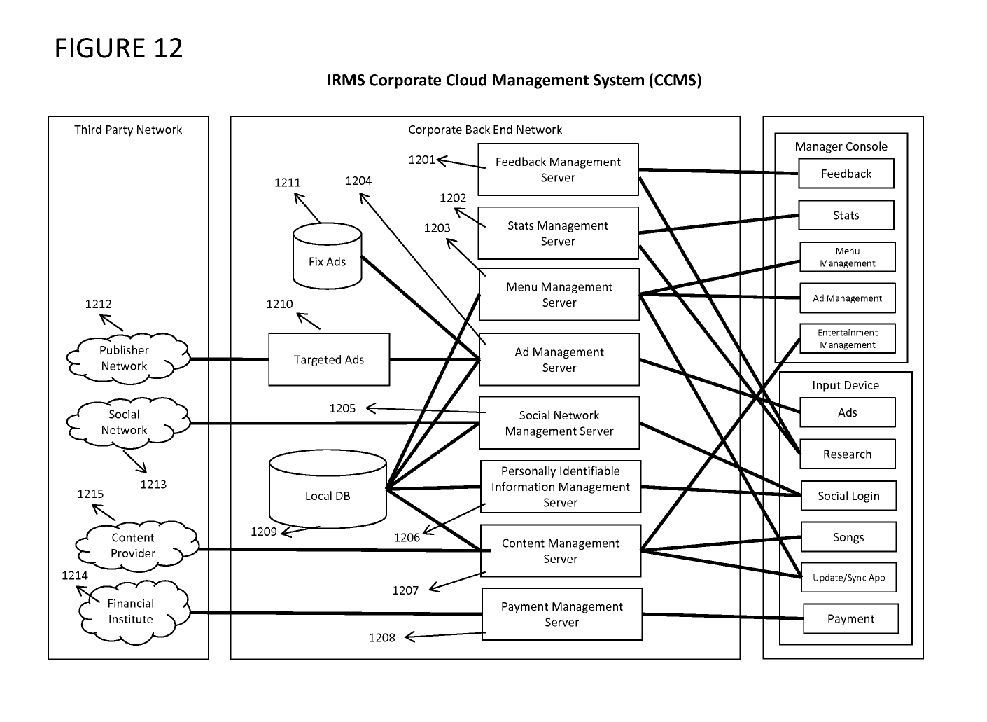

FIG. 12 is a diagram that details the functionality of the CCMS. In order to communicate with and manage the ISSs of multiple locations, the Back End System may include, but is not limited to, software modules for: a Feedback Management Server 1201 to collect and store feedback and surveys from each ISS, a Stats Management Server 1202 to collect and store payment and usage stats from each ISS, a Menu Management Server 1203 to allow consistent menu management throughout a multiple restaurants, an Ad Management Server 1204 to push ads directly to each ISS, a Social Network Management Server 1205 to more efficiently aggregate outside social media data and filter requests from each ISS and report social media data back to each ISS, an Individual Record Management Server 1206, an Content Management Server 1207 to manage media and game access for each ISS, and a Payment Management Server 1208 to process payments from each ISS.

Each individual store's ISS SM is configured to sync regularly with the Back End Server's corresponding modules to update and be updated by the corporate database. For example, when the corporate office changes menu items, the office would enter that data into the Back End Server's database 1209, the Menu Management Server would recognize the change in the database and push this change to the ISS SMs of the selected places where the menu change would take effect.

CCMS is also configured to mine data and to extract useful information that helps corporate to make strategic decisions. Based on the collected data, Corporate can modify menu items, see the performance of individual store in comparison with others, get recommendations from the system based on the historic data, improves based on the reviews, manages multiple revenue streams, generate reports for the execs, set alarms or raise flags on preset conditions, forecasts sales and revenue, manages inventory, manages supply chain and create charts and graphs.

Ads are served by two methods, targeted ads and fixed ads. Targeted ads 1210 are served based on the data collected from user behavior, demographics, geographics, psychographics etc. while fixed non-targeted ads 1211, which are sponsored ads will show to any user not based on specific demographics are served from a fixed ad database. Ads are further supported by publisher network 1212 as social network backed by social network services 1213. Payment is supported by payment processor and financial services 1214. Entertainment contents are served by the content provider 1215.

We claim:

1. A hospitality management system having a computer server configured to operate a hospitality management software, a computer input device and display, the system further having a software interface configured to interact with the hospitality management software, the computer input device, and display, the system further having an improvement comprising:
a first software component configured to display a digital menu stored on the computer server, the digital menu being an electronic representation of menu items offered for purchase at an establishment;
a second software component configured to receive from the input device a digital rating for one or more menu items and further configured to store the digital rating in a database of digital ratings for said one or more menu items and linking said database of digital ratings to the electronic representation of menu items; and
a third software component configured to provide access to the database of digital ratings such that a consumer accessing the digital menu has access to the database of digital ratings.

2. The system of claim 1, wherein the digital rating includes one or more of the following: a customer's numerical rating of a menu item, a digital like, a digital dislike, an electronic comment reflecting the menu item

3. The system of claim 1 further comprising a fourth software component configured to generate reports on the database of digital ratings.

4. The system of claim 1, wherein the system is in communication with a network server configured to communicate with two or more similarly configured systems for the management of multiple establishments.

5. The system of claim 4 further comprising a fourth software component configured to generate reports on the database of digital ratings from multiple establishments.

6. The system of claim 1, wherein the system is in communication with a network server configured to electronically publish the digital menu and the database of digital ratings.

7. The system of claim 6, wherein the system further includes a fifth software component configured to receive digital ratings through the network server and further configured to update the database of digital ratings based on the receipt thereof

8. The system of claim 1, wherein the computer input device and display is a tablet computing device embedded into or fixed onto a tabletop.

9. A hospitality management system having a computer server configured to operate a hospitality management software, a computer input device and display, the system further having a software interface configured to interact with the hospitality management software, the computer input device, and display, the system further having an improvement comprising:
a first software component configured to display an establishment venue seating and/or table availability;
a second software component configured to store a pre-stored customer seating preference; and
a third software component configured to compare the pre-stored customer seating preference to the establishment venue seating and table availability and further configured to reserve a table base on a match in the comparison.

10. The system of claim 9, wherein the computer input device and display is a tablet computing device embedded into or fixed onto a tabletop.

11. A hospitality management system having a computer server configured to operate a hospitality management software, a computer input device and display, the system further having a software interface configured to interact with the hospitality management software, the computer input device, and display, the system further having an improvement comprising:
a first software component configured to display a digital menu stored on the computer server, the digital menu being an electronic representation of menu items offered for purchase at an establishment; and
wherein the first software component is configurable to filter digital menu items based on one or more preferences received from the input device such that the display of digital menu items are restricted based on the one or more preferences received from the input device.

12. The system of claim 11, wherein the one or more preferences is selected from one or more of the following inputs: dietary restrictions, allergens, child selection, and no restrictions.

13. The system of claim 11, wherein the computer input device and display is a tablet computing device embedded into or fixed onto a tabletop.

14. A hospitality management system having a computer server configured to operate a hospitality management software, a computer input device and display, the system further having a software interface configured to interact with the hospitality management software, the computer input device, and display, the system further having an improvement comprising:
a first software component configured to display a digital menu stored on the computer server, the digital menu being an electronic representation of menu items offered for purchase at an establishment;
a second software component configured to receive and store user generated images of said menu items via the internet or mms messaging; and
a third software component configured to retrieve the stored user generated images from the server and display said images in conjunction with the digital menu on the computer input device and display.

15. The system of claim 14, wherein the computer input device and display is a tablet computing device embedded into or fixed onto a tabletop.

16. A hospitality management system having a computer server configured to operate a hospitality management software, a computer input device and display, the system further having a software interface configured to interact with the hospitality management software, the computer input device, and display, the system further having an improvement comprising:
a software component configured to communicate with the computer server to send messages from one computer input device and display to another computer input device and display within a hospitality venue computer server network;
said software component additionally configured for a restaurant chef to communicate through the computer input device and display messages concerning the status of food that was ordered to an additional computer input device and display monitored by wait staff or customers; and
said software component additionally configured for a customer to communicate through the computer input device and display messages concerning need for service to an additional computer input device and display monitored by wait staff

17. The system of claim 16, wherein the computer input device and display is a tablet computing device embedded into or fixed onto a tabletop.

18. A hospitality management system having a computer server configured to operate a hospitality management software, a computer input device and display, the system further having a software interface configured to interact with the hospitality management software, the computer input device, and display, the system further having an improvement comprising:
a first software component configured to store a database containing advertisements, said advertisements based on the geographic location of the computer input device and display and/or pre-defined user profiles based on age, gender, or linked social media accounts;
a second software component configured to receive, store, and display an advertisement created by a hospitality venue customer at the hospitality venue within a selected geographic location through the computer input device and display; and
a third software component configured for customers at a hospitality venue linked to the computer server within the selected geographic location to retrieve and display said advertisements or said customer generated advertisements on an additional computer input device and display.

19. The system of claim 18, wherein the computer input device and display is a tablet computing device embedded into or fixed onto a tabletop.

20. A modular system configured for placement in a restaurant table, the system comprising:
a processor configured to process and relay data between a server and an electronic device;
a pressure sensor positioned beneath the top surface of the restaurant table, the pressure sensor in communication with the processor and being configured to detect a change of pressure beneath a portion of the top surface;
a near field communication antenna positioned beneath the top surface of the restaurant table, the near field communication antenna in communication with the processor and being configured to provide wireless charging and data exchange to a mobile device;
a capacitive or equivalent touch sensitive grid positioned beneath the top surface of the restaurant table, the capacitive touch sensitive grid in communication with the processor and being configured to act as a human interface device for an electronic device; and
a biometric sensor positioned beneath the top surface of the restaurant table, the biometric sensor in communication with the processor and being configured to detect and relay biometric information such as fingerprint data or heart rate data to an electronic device.

21. The system of claim 20, wherein the electronic device is a tablet computing device embedded into or fixed onto the restaurant table.

22. The system of claim 21, wherein the server is configured to store customer profiles including pre-entered payment information that can be accessed and used to make payments when the customer uses the biometric sensor to input their fingerprint.

23. The system of claim 21, wherein when a beverage glass is placed on top of the pressure sensor, the pressure sensor in communication with the processor relays the pressure or weight data of the beverage glass to the server, the server being further configured to alert an second electronic device carried by a restaurant wait staff when the beverage glass is low or empty.

24. A restaurant tabletop comprising:
at least one tablet computing device secured onto or embedded into said tabletop;
said tablet computing device configured to communicate with a computer server; and
a power supply or removable battery fixed under or embedded into said tabletop and connected to said tablet computing device.

25. The tabletop of claim 24, wherein the tabletop additionally comprises of a point-of-sale terminal assembled into or fixed onto said tabletop configured to communicate with tablet computing device and process mobile payments.

26. The tabletop of claim 24, wherein the tablet computing device is fixed onto the edge of said tabletop via a hinge mechanism that allows the tablet computing device to freely rotate one hundred and eighty (180) degrees such that the tablet computing device may sit on the top of the tabletop or rotate to hide under the table top.

27. The tabletop of claim 24, wherein the tablet computing device is mounted to the top of the tabletop and locked between a set of rails allowing the tablet computing device to freely translate on the table top in the direction of the rails, the ends of the rails having stopping members to prevent the tablet computing device from falling off the tabletop.

28. The tabletop of claim 27, wherein the rails include stopping members at one end and a hinge assembly on the other end to allow the tablet computing device to slide and lock into a position further allowing the tablet computing device to be rotated and hid under the tabletop when not in use.

29. The tabletop of claim 24, wherein the tabletop additionally comprises a Scent Synthesizer and cartridge, in communication with the tablet computing device, configured to provide food aroma of restaurant menu items.

30. The tabletop of claim 24, wherein the tabletop additionally comprises of a holographic display, in communication with the tablet computing device, wherein the tablet computing device is configured to display three dimensional views of digital menu items on the holographic display.

31. The tabletop of claim 24, wherein the tabletop additionally comprises of a printer in communication with the tablet computer and said printer is connected to the power supply.
